(19) United States
(12) Patent Application Publication
(10) Pub. No.: US 2011/0273145 A1
(43) Pub. Date: Nov. 10, 2011

(54) CHARGE CONTROL CIRCUIT

(75) Inventors: Shigeyuki Yamakita, Miyagi (JP); Toshinori Fukasawa, Kanagawa (JP)

(73) Assignee: PANASONIC CORPORATION, Osaka (JP)

(21) Appl. No.: 13/144,257

(22) PCT Filed: Nov. 26, 2009
(86) PCT No.: PCT/JP2009/006407

§ 371 Date: Jul. 12, 2011

(30) Foreign Application Priority Data
Jan. 13, 2009 (JP) 2009-004471

(51) Int. Cl. H02J 7/06

(52) U.S. Cl. 320/163

(57) ABSTRACT

A challenge to be met by an aspect of the present invention is to provide a charge control circuit that prevents occurrence of a decrease in battery capacity even when a battery stays in a connection with an external power supply and that induces neither battery deterioration nor overcharge. A first switch (2) is connected to a point among an external power supply (60), a load (80), and a secondary battery (70). When the secondary battery (70) is charged with the external power supply (60), the first switch (2) is turned on. When the secondary battery (70) has accomplished full charge, the first switch 82) is turned off. Electric discharge from the secondary battery (70) to the load (80) is shut off at full charge of the secondary battery (70), so that a load current fed from the secondary battery (70) does not flow and, hence, a decrease in battery capacity of the secondary battery (70) which would be caused by the load (80) does not take place. Further, electric power feed from the external power supply (60) to the secondary battery (70) is also shut off by turning off the first switch (2) at full charge of the secondary battery (70). Hence, neither battery deterioration nor overcharge is induced.

### TECHNICAL FIELD

The present invention relates to a charge control circuit for charging a rechargeable secondary battery.

### BACKGROUND ART

Patent Literature 1 discloses a charge control circuit that varies a charge current to continually perform charging operation at full charge by use of a microcurrent, thereby maintaining a battery voltage. Further, Patent Literature 2 discloses a charge control device that varies a charge voltage (a final voltage) to set a safe charge voltage at full charge and continually perform charging operation, thereby maintaining a battery voltage.

FIG. 21 is a block diagram showing a general configuration of a common related-art charge control circuit. A charge control circuit 50 shown in the figure includes an FET 51 connected to a point between an external power supply 60 and a secondary battery 70; and a gate voltage control unit 52 that turns on the FET 51 when the secondary battery 70 is charged by the external power supply 60 and that turns off the FET 51 when the secondary battery 70 has accomplished full charge. A load 80 is; for instance, a main unit of a portable phone, and operates upon receipt of electric power fed from the external power supply 60 or the secondary battery 70.

FIG. 22 is a timing chart showing operation of the charge control circuit 50. Operation of the external power supply 60, a charge current and a battery voltage of the secondary battery, and operation of the FET 51, all of which are illustrated in the figure, correspond to an example general flow of charge control flow of, in particular, a lithium ion battery. In the figure, when the external power supply 60 is turned on, the gate voltage control unit 52 turns on the FET 51. A charge current thereby flows into the secondary battery 70, whereupon the battery voltage of the secondary battery 70 rises. After the secondary battery 70 has reached a charge-complete voltage, the charge current gradually decreases from then on. When the charge current has fallen below a predetermined threshold value, a charge becomes completed. When a charge period of the secondary battery 70 ends, the gate voltage control unit 52 turns off the FET 51. The secondary battery 70 thereby finishes its charge. The electric current stops flowing from the external power supply 60 to the load 80 as a result of the FET 51 being turned off. Instead, since the electric current flows from the secondary battery 70 to the load 80, the battery voltage of the secondary battery 70 gradually drops.

### CITATION LIST

### Patent Literature

Patent Literature 1: JP-A-62-37023
Patent Literature 2: JP-A-9-56078

### SUMMARY OF THE INVENTION

### Technical Problem

However, the charge control circuit described in connection with Patent Literature 1 completely turns off the FET after accomplishment of full charge, thereby completely shutting off the electric power feed from the external power supply. Therefore, an electric current flows from the secondary battery to the load even when the external power supply stays in a connection with the secondary battery, thereby raising a problem of a decrease in battery capacity. Specifically, even when an electronic device having a charge control circuit is in a connection with an external power supply, battery capacity decreases. The charge control circuit described in connection with Patent Literature 2 repeats states of full charge and recharge when the battery stays in a connection with the external power supply, which may induce battery deterioration or overcharge.

The present invention has been conceived in light of the circumstance and aims at providing a charge control circuit that prevents occurrence of a decrease in battery capacity even when a battery stays in a connection with an external power supply and that induce neither battery deterioration nor overcharge.

### Solution to Problem

A charge control circuit according to an aspect of the present invention includes a first switch connected to a point among an external power supply, a load, and a secondary battery; a switch control unit that performs control so as to turn on the first switch when the secondary battery is charged with the external power supply and turn off the first switch when the secondary battery has accomplished full charge; and a feed control unit that controls power feed from the external power supply to the secondary battery or the load.

By means of the configuration, since the first switch is turned off at full charge of the secondary battery, the electric discharge from the secondary battery to the load is shut off, and a load current, which would be fed from the secondary battery, does not flow. In this way a decrease in capacity of the secondary battery caused by the load does not take place. Moreover, the first switch is turned off at full charge of the secondary battery to thus shut off the power feed from the external power supply as well. Therefore, neither battery deterioration nor overcharge takes place.

Moreover, the above configuration additionally includes a second switch connected between the secondary battery and the feed control unit and a third switch connected between the first switch and the second switch, and the switch control unit turns on the first switch and the second switch and turn off the third switch when the secondary battery is charged with the external power supply. When the secondary battery has accomplished full charge, the switch control unit turns off the first switch and the second switch and turns on the third switch.

By means of the configuration, the first switch is turned off at full charge of the secondary battery, so that electric discharge from the secondary battery to the load can be shut off. Moreover, the feed control unit can detect a battery voltage of the secondary battery by way of the second switch at charge of the secondary battery. Furthermore, the feed control unit can detect a load voltage by way of the third switch at full charge of the secondary battery and can adjust a voltage of the power supply fed to the load.

In the configuration, the second switch and the third switch can be substituted for amplifiers, respectively.

In the configuration, another amplifier can be further connected between the feed control unit and the second switch.

In the configuration, a diode can be further connected in a forward direction from the secondary battery to the load. In a case where an electric current consumed by the load exceeds feed capability of the external power supply or large variations occur in the electric current of the load and poor response of the external power supply take place on the occasion of power feed to the load after accomplishment of full charge, it becomes possible to feed electric power from the secondary battery to the load as a result of the diode being set in the forward direction from the secondary battery to the load. For instance, when the charge control circuit is applied to a portable phone, when large power is required as a result of an increase in transmission power, electric power can be also fed from the secondary battery as well as from the external power supply.

The configuration can be further provided with a battery detection section that detects presence or absence of the secondary battery or that a voltage of the secondary battery is substantially zero so as to control the switch control unit. By virtue of provision of the battery detection section, when the secondary battery is absent or when the voltage of the secondary battery is substantially zero (in a deeply discharged state), it becomes possible to feed electric power from the external power supply to the load by turning off both the first switch and the second switch and turning on the third switch.

In the configuration, the diode can be connected in a reverse direction from the secondary battery to the load. The diode is connected in a reverse direction; specifically, a cathode of the diode is connected to the secondary battery and an anode of the diode is connected to the load, whereby the electric discharge from the secondary battery to the load can be shut off.

### Advantageous Effects of the Invention

The present invention can provide a charge control circuit that prevents occurrence of a decrease in battery capacity even when a battery stays in a connection with an external power supply and that induces neither battery deterioration nor overcharge.

### BRIEF DESCRIPTION OF THE DRAWINGS

FIG. 1 is a block diagram showing a general configuration of a charge control circuit according to a first embodiment of the present invention.

FIG. 2 is a timing chart showing operation of the charge control circuit shown in FIG. 1.

FIG. 3 is a partially enlarged view of the timing chart of FIG. 2.

FIG. 4 is a block diagram showing a general configuration of a charge control circuit according to a second embodiment of the present invention.

FIG. 5 is a timing chart showing operation of the charge control circuit shown in FIG. 4.

FIG. 6 is a partially enlarged view of the timing chart of FIG. 5.

FIG. 7 is a block diagram showing a general configuration of a charge control circuit according to a third embodiment of the present invention.

FIG. 8 is a timing chart showing operation of the charge control circuit shown in FIG. 7.

FIG. 9 is a partially enlarged view of the timing chart of FIG. 8.

FIG. 10 is a block diagram showing a general configuration of a charge control circuit according to a fourth embodiment of the present invention.

FIG. 11 is a timing chart showing operation of the charge control circuit shown in FIG. 10.

FIG. 12 is a partially enlarged view of the timing chart of FIG. 11.

FIG. 13 is a block diagram showing a general configuration of a charge control circuit according to a fifth embodiment of the present invention.

FIG. 14 is a timing chart showing operation of the charge control circuit shown in FIG. 13.

FIG. 15 is a partially enlarged view of the timing chart of FIG. 14.

FIG. 16 is a block diagram showing a general configuration of a charge control circuit according to a sixth embodiment of the present invention.

FIG. 17 is a block diagram showing a general configuration of a charge control circuit according to a seventh embodiment of the present invention.

FIG. 18 is a timing chart showing operation of the charge control circuit shown in FIG. 17.

FIG. 19 is a block diagram showing a general configuration of a charge control circuit according to an eighth embodiment of the present invention.

FIG. 20 is a timing chart showing operation of the charge control circuit shown in FIG. 19.

FIG. 21 is a block diagram showing a general configuration of a related art charge control circuit.

FIG. 22 is a timing chart showing operation of the charge control circuit shown in FIG. 21.

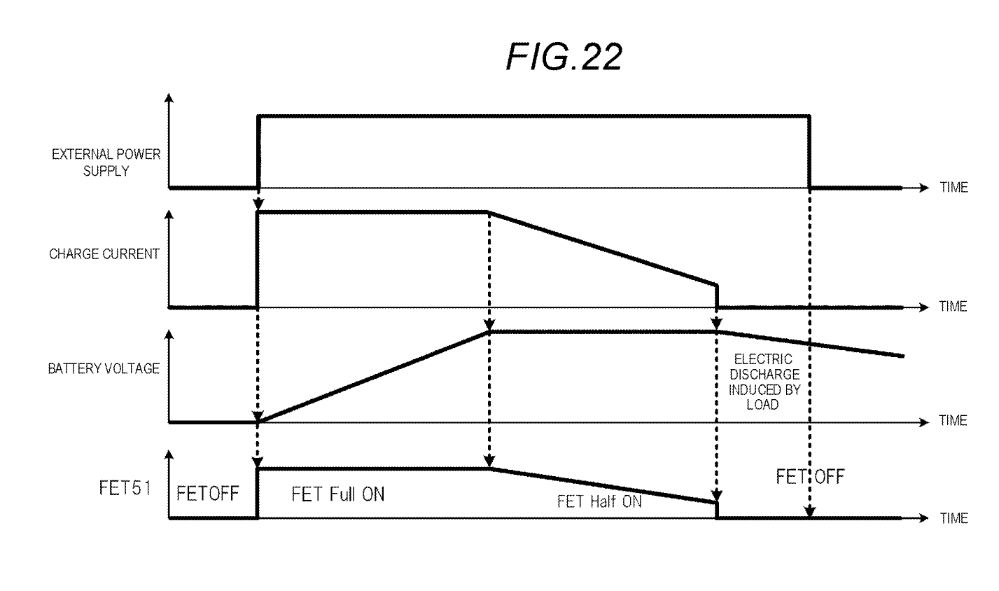

### DESCRIPTION OF EMBODIMENTS

Suitable embodiments for implementing the present invention are hereinbelow described in detail by reference to the drawings.

### First Embodiment

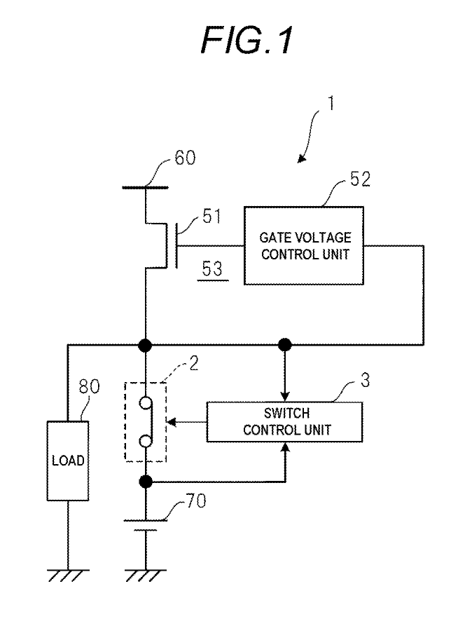

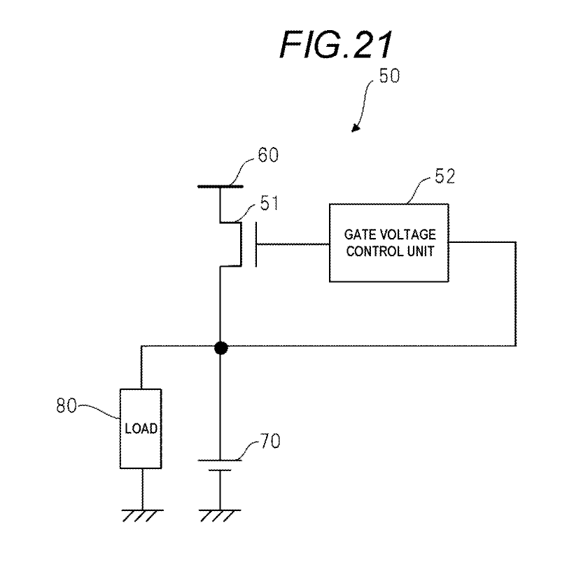

FIG. 1 is a block diagram showing a general configuration of a charge control circuit according to a first embodiment of the present invention. In FIG. 1, elements common to FIG. 21 to which a reference has previously been made are assigned the same reference numerals. A charge control circuit 1 of the present embodiment has a first switch 2 connected to a point among an external power supply 60, a load 80, and a secondary battery 70 and a switch control unit 3 that performs control so as to turn on the first switch 2 during charge of the secondary battery 70 and turn off the first switch 2 at full charge of the secondary battery. An FET 51 and a gate voltage control unit 52 make up an electric power feed control unit 53.

The first switch 2 usually stays in an ON position and is of normally closed type. The switch control unit 3 detects a voltage value of the secondary battery 70 as well as a voltage value of the external power supply 60. When determined that the voltage value of the secondary battery 70 is less than a predetermined threshold value, the switch control unit 3 turns on the first switch 2. When the secondary battery 70 accomplishes full charge, the switch control unit 3 turns off the first switch 2. The terms “predetermined threshold value” corresponds to a charge complete voltage that is a value intended for protecting the battery from being charged to an overvoltage. The first switch 2 is turned off at full charge of the secondary battery 70, to thus shut off the secondary battery 70 from the external power supply 60 and the load 80. An electric discharge from the secondary battery 70 to the load 80 can thereby be shut off, and a decrease in battery capacity, which would otherwise be caused by the load 80, can be prevented. Electric power feed from the external power supply 60 to the secondary battery 70 can also be shut off. Therefore, states of full charge and recharge are not repeated, so that neither deterioration nor overcharge of the secondary battery 70 is induced.

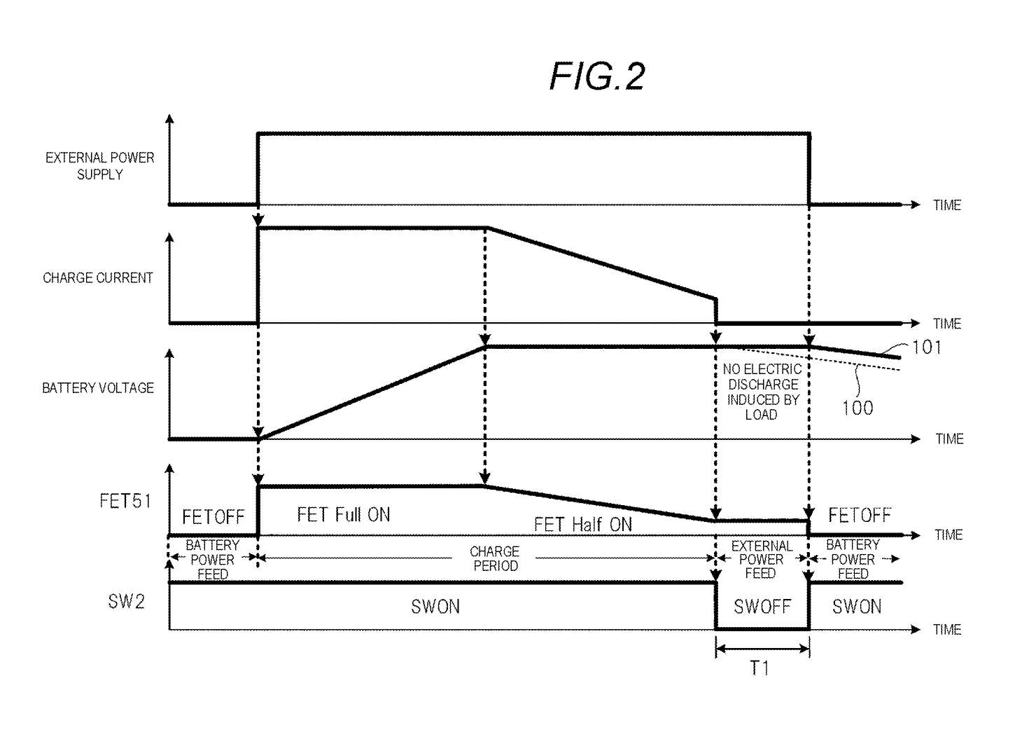

FIG. 2 is a timing chart showing operation of the charge control circuit 1 of the present embodiment. The external power supply 60, the charge current and the battery voltage of the secondary battery, and the operation of the FET 51, all of which are shown in the figure, correspond to an example general charge control flow of, in particular, a lithium ion battery. In the figure, when the external power supply 60 is turned on, the gate voltage control unit 52 turns on the FET 51. Since the first switch 2 stays in an ON position at this time, a charge current flows into the secondary battery 70, whereby charge of the secondary battery 70 is commenced. When charge is commenced, the battery voltage of the secondary battery 70 rises, so that the secondary battery 70 reaches a charge complete voltage. The charge current gradually drops from then on. When the charge current has fallen below a predetermined threshold value, the charge completes. When a charge period of the secondary battery 70 ends, the gate voltage control unit 52 brings the FET 51 into a near-OFF state (a half-ON state), thereby varying (chiefly increasing) ON resistance according to a load current. Specifically in the half-ON state of the FET 51 (a state where the ON resistance value of the FET is made variable), the charge current is adjusted while the battery voltage is maintained, and charge of the secondary battery 70 thereby ends. Further, simultaneously with deactivation the FET 51 or at a subsequent time, the switch control unit 3 turns off the first switch 2. The first switch 2 remains deactivated until the external power supply 60 is turned off. The first switch 2 is turned on concurrently with deactivation of the external power supply 60, whereupon the FET 51 is also turned off.

As a result of the first switch 2 being turned off after full charge of the secondary battery 70, electric discharge from the secondary battery 70 to the load 80 is not performed. A time shift in battery voltage designated by a dotted line 100 shown in FIG. 2 is caused by a related art charge control circuit 50 not having the first switch 2. When compared with a time shift in battery voltage of the charge control circuit 1 of the present embodiment designated by a solid line 101, it is found that the time shift in battery voltage designated by the dotted line 100 shows a large number of electric discharge from the secondary battery 70.

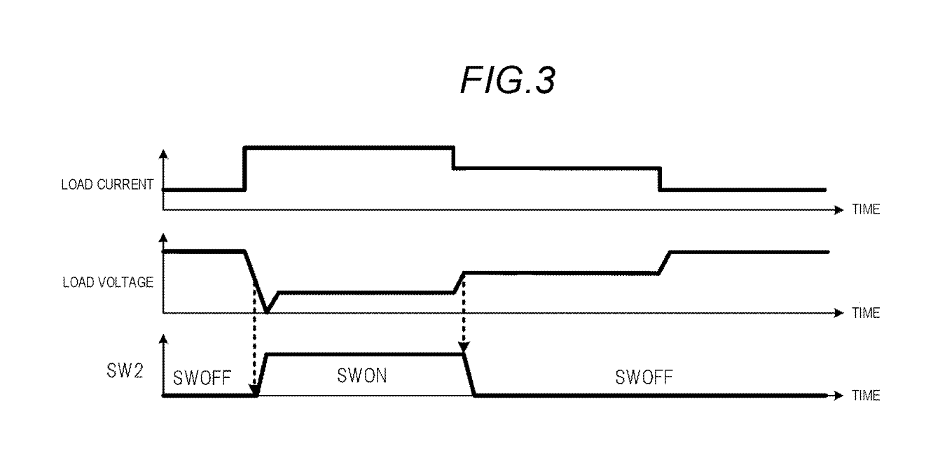

FIG. 3 is a timing chart showing a load current, a load voltage, and a state of the first switch 2 that are achieved during a period T1 in FIG. 2. There may be a case where electric power feed from the external power supply 60 will fail to catch up with an increase in load current even when the first switch 2 is turned off to shut off the electric discharge from the secondary battery 70 to the load 80. Accordingly, the gate voltage control unit 52 and the switch control unit 3 control turning on and off the FET 51 and the first switch 2 according to a state of the load current. For instance, when the load 80 is a portable phone, the load current achieved during transmission operation becomes greater than a load current achieved during receiving operation. As shown in FIG. 3, when the load current momentarily increases, the load voltage drops. However, when the load voltage falls below a predetermined threshold voltage, the switch control unit 3 turns on the first switch 2. The term “predetermined threshold value” corresponds to a charge complete voltage that is a value for protecting the battery from being charged to an overvoltage. In addition to the electric power feed from the external power supply 60, electric power feed from the secondary battery 70 is also provided, so that the load voltage rises. Subsequently, when a decrease in load current and a rise in load voltage take place, the switch control unit 3 turns off the first switch 2.

As mentioned above, in the charge control circuit 1 of the present embodiment, the first switch 2 is connected to the point among the external power supply 60, the load 80, and the secondary battery 70. During charge of the secondary battery 70 performed by the external power supply 60, the first switch 2 is turned on. At full charge of the secondary battery 70, the first switch 2 is turned off, whereby the electric discharge from the secondary battery 70 to the load 80 is shut off at full charge of the secondary battery 70, and flow of the load current, which would be fed from the secondary battery 70, is prevented. A decrease in battery capacity of the secondary battery 70, which would otherwise be caused by the load 80, is prevented. Moreover, as a result of the first switch 2 being turned off at full charge of the secondary battery 70, electric power feed from the external power supply 60 to the secondary battery 70 is also shut off, so that neither battery deterioration nor overcharge takes place.

### Second Embodiment

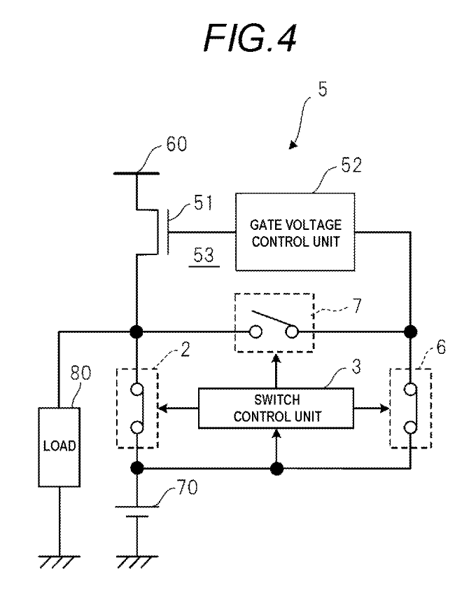

FIG. 4 is a block diagram showing a general configuration of a charge control circuit according to a second embodiment of the present invention. In FIG. 4, elements common to FIG. 1 to which a reference has been made are assigned the same reference numerals. A charge control circuit 5 of the present embodiment corresponds to a configuration in which a second switch 6 and a third switch 7 is added to the charge control circuit 1 shown in FIG. 1. The second switch 6 is connected to a point between the secondary battery 70 and the gate voltage control unit 52, and the third switch 7 is connected to a point between the first switch 2 and the second switch 6. During the secondary battery 70 being charged by the external power supply 60, the switch control unit 3 turns on the first switch 2 and the second switch 6 and turns off the third switch 7. At full charge of the secondary battery 70, the switch control unit turns off the first switch 2 and the second switch 6 and turns on the third switch 7.

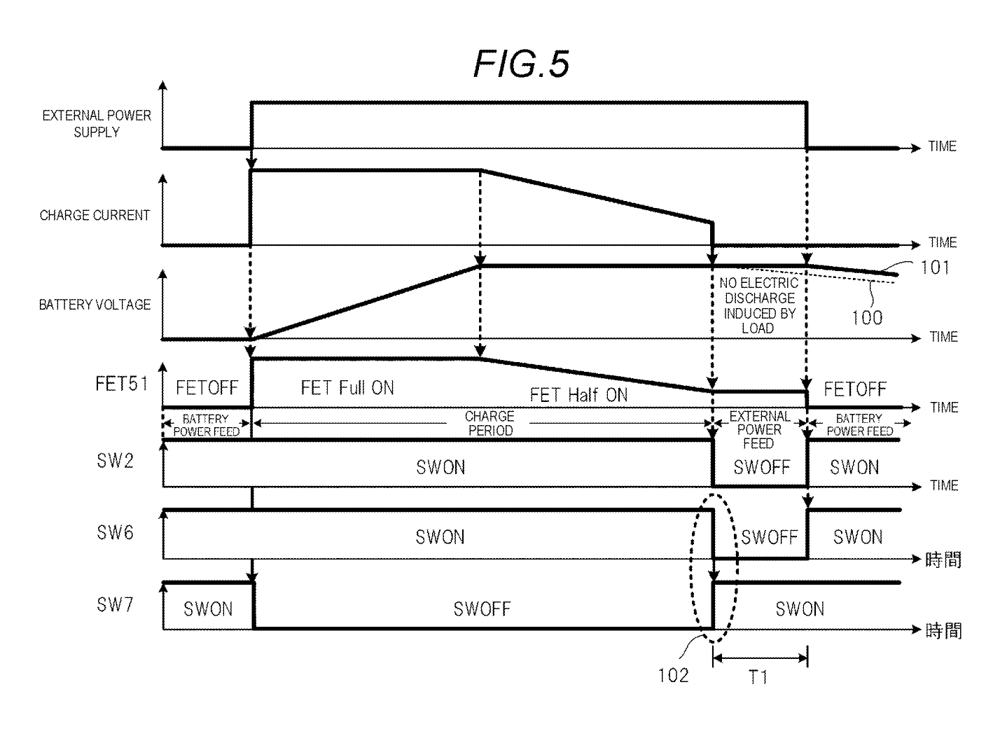

FIG. 5 is a timing chart showing operation of the charge control circuit 5 of the present embodiment. The operation of the external power supply 60, the charge current and the battery voltage of the secondary battery, and the operation of the FET 51, all of which are shown in the figure, correspond to an example general charge control flow of, in particular, a lithium ion battery. In the figure, when the external power supply 60 is turned on, the gate voltage control unit 52 turns on the FET 51. Since the first switch 2 stays in an ON position at this time, a charge current flows into the secondary battery 70, whereby charge of the secondary battery 70 is commenced. When charge is commenced, the battery voltage of the secondary battery 70 rises, so that the secondary battery 70 reaches a charge complete voltage. Subsequently, the charge current gradually drops from then on. When the charge current has fallen below a predetermined threshold value, the charge completes. When a charge period of the secondary battery 70 ends, the gate voltage control unit 52 brings the FET 51 into a near-OFF state (a half-ON state), thereby varying (chiefly increasing) ON resistance according to a load current. Specifically, in the half-ON state of the FET 51 (a state where the ON resistance value of the FET is made variable), the charge current is adjusted while the battery voltage is maintained, and charge of the secondary battery 70 thereby ends. Further, simultaneously with deactivation the FET 51 or at a subsequent time, the switch control unit 3 turns off the first switch 2 and the second switch 6 and also turns on the third switch 7. The first switch 2 and the second switch 6 remain deactivated until the external power supply 60 stops feeding electric power. The first switch 2 and the second switch 6 are turned on concurrently with stoppage of electric power feeding (deactivation) of the external power supply 60. The FET 51 it completely turned off at this time.

The gate voltage control unit 52 can directly detect the battery voltage of the secondary battery 70 by means of the second switch 6 being turned on during charge of the secondary battery 70. Further, as a result of both the first switch 2 and the second switch 6 being turned off at full charge of the secondary battery 70, electric discharge from the secondary battery 70 to the load 80 does not take place. A time shift in battery voltage designated by the dotted line 100 in FIG. 5 is induced by the related art charge control circuit 50 not having the first switch 2. When compared with a time shift in battery voltage of the charge control circuit 5 of the present embodiment designated by the solid line 101, it is found that the time shift in battery voltage designated by the dotted line 100 shows a large number of electric discharge from the secondary battery 70. At full charge of the secondary battery 70, the first switch 2 and the second switch 6 are turned off, and the third switch 7 is turned on. Therefore, the gate voltage control unit 52 can adjust the voltage of the power supply fed to the load 80. During electric power feed from the external power supply 60, the second switch 6 and the third switch 7 are not concurrently turned off at timing designated by a dotted line 102 shown in FIG. 5.

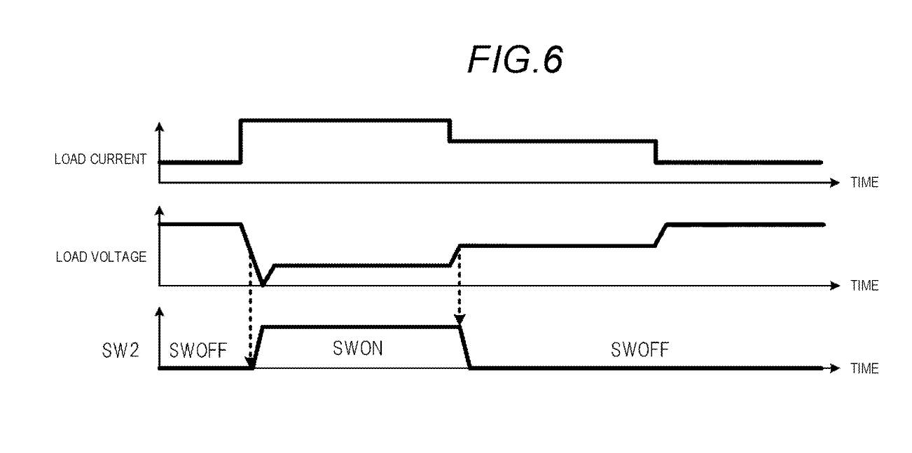

FIG. 6 is a timing chart showing a load current, a load voltage, a state of the first switch 2, and a state of the second switch 6 that are achieved during a period T1 in FIG. 5. There may be a case where electric power feed from the external power supply 60 will fail to catch up with an increase in load current even when both the first switch 2 and the second switch 6 are turned off to shut off the electric discharge from the secondary battery 70 to the load 80. Accordingly, the gate voltage control unit 52 and the switch control unit 3 control turning on and off the FET 51 and the first switch 2 according to the state of the load current. For instance, when the load 80 is a portable phone, the load current achieved during transmission operation becomes greater than a load current achieved during receiving operation. As shown in FIG. 6, when the load current momentarily increases, the load voltage drops. However, when the load voltage falls below a predetermined threshold voltage, the switch control unit 3 turns on both the first switch 2 and the second switch 6. In addition to the electric power feed from the external power supply 60, electric power feed from the secondary battery 70 is thereby provided, so that the load voltage rises. Subsequently, when a decrease in load current and a rise in load voltage take place, the switch control unit 3 turns off the first switch 2 and the second switch 6.

As mentioned above, in the charge control circuit 5 of the present embodiment, the first switch 2 is turned off at full charge of the secondary battery 70, so that the electric discharge from the secondary battery 70 to the load 80 can be shut off. During charge of the secondary battery 70, the gate voltage control unit 52 can detect the battery voltage of the secondary battery 70 by way of the second switch 6. Further, the gate voltage control unit 52 can detect a load voltage by way of the third switch 7 at full charge of the secondary battery 70 and can adjust the source voltage fed to the load.

### Third Embodiment

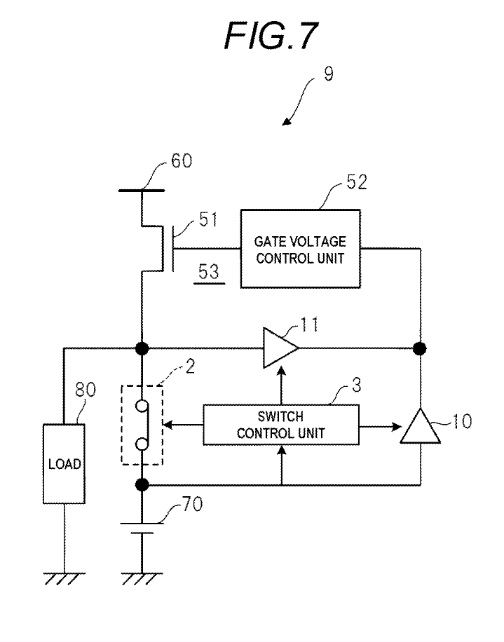

FIG. 7 is a block diagram showing a general configuration of a charge control circuit according to a third embodiment of the present invention. In FIG. 7, elements common to FIG. 4 to which a reference has been made are assigned the same reference numerals. A charge control circuit 9 of the present embodiment corresponds to a configuration in which the second switch 6 in the charge control circuit 5 shown in FIG. 4 is substituted for an amplifier 10 and the third switch 7 in the same is also substituted for an amplifier 11.

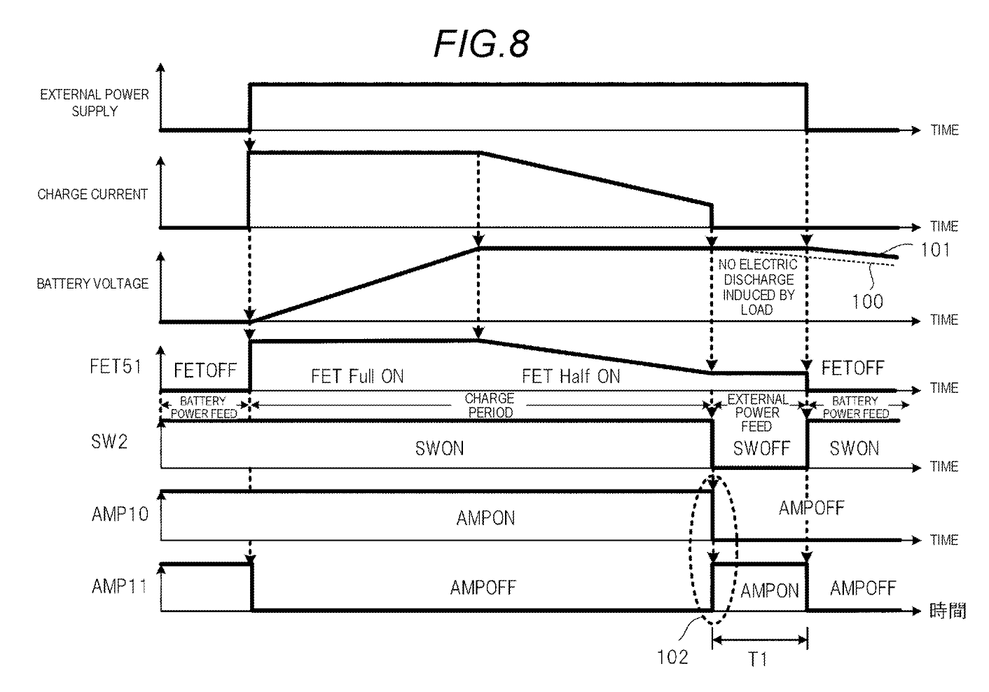

FIG. 8 is a timing chart showing operation of the charge control circuit 9 of the present embodiment. The operation of the external power supply 60, the charge current and the battery voltage of the secondary battery, and the operation of the FET 51, all of which are shown in the figure correspond to an example general charge control flow of, in particular, a lithium ion battery. In the figure, when the external power supply 60 is turned on, the gate voltage control unit 52 turns on the FET 51. Since the first switch 2 stays in an ON position at this time, a charge current flows into the secondary battery 70, whereby charge of the secondary battery 70 is commenced. When charge is commenced, the battery voltage of the secondary battery 70 rises, so that the secondary battery 70 reaches a charge complete voltage. Subsequently the charge current gradually drops from then on. When the charge current has fallen below a predetermined threshold value, the charge completes. Further, the gate voltage control unit 52 turns on the FET 51, and the switch control unit 3 simultaneously brings the amplifier 10 into an operating state. Further, the first switch 2 remains in an ON position (a normally closed state).

When a charge period of the secondary battery 70 ends, the gate voltage control unit 52 brings the FET 51 into a near-OFF state (a half-ON state), thereby varying (chiefly increasing) ON resistance according to a load current. Specifically in the half-ON state of the FET 51 (a state where the ON resistance value of the FET is made variable), the charge current is adjusted while the battery voltage is maintained, and charge of the secondary battery 70 thereby ends. Further, simultaneously with deactivation the FET 51 or at a subsequent time, the switch control unit 3 turns off the first switch 2 and also turns off the amplifier 10. Further, the amplifier 11 is turned on. The deactivated state of the first switch 2 and activated state of the amplifier 11 continue until the external power supply 60 is turned off. As a result of the external power supply 60 being turned off, the first switch 2 is turned on, and the amplifier 11 is turned off. The amplifier 10 still remains in the deactivated state. The FET 51 is also turned off.

The gate voltage control unit 52 can directly detect the battery voltage of the secondary battery 70 by means of the amplifier 10 being turned off during charge of the secondary battery 70. Further, as a result of the first switch 2 being turned off and the amplifier 10 being turned off at full charge of the secondary battery 70, electric discharge from the secondary battery 70 to the load 80 does not take place. A time shift in battery voltage designated by the dotted line 100 in FIG. 8 is induced by the related art charge control circuit 50 not having the first switch 2. When compared with a time shift in battery voltage of the charge control circuit 9 of the present embodiment designated by the solid line 101, it is found that the time shift in battery voltage designated by the dotted line 100 shows a large number of electric discharge from the secondary battery 70. At full charge of the secondary battery 70, the first switch 2 is turned off; the amplifier 10 is turned off; and the amplifier 11 is turned on. Therefore, the gate voltage control unit 52 can adjust the voltage of the power supply fed to the load 80. During electric power feed from the external power supply 60, both the amplifier 10 and the amplifier 11 are not concurrently turned off at timing designated by the dotted line 102 shown in FIG. 8.

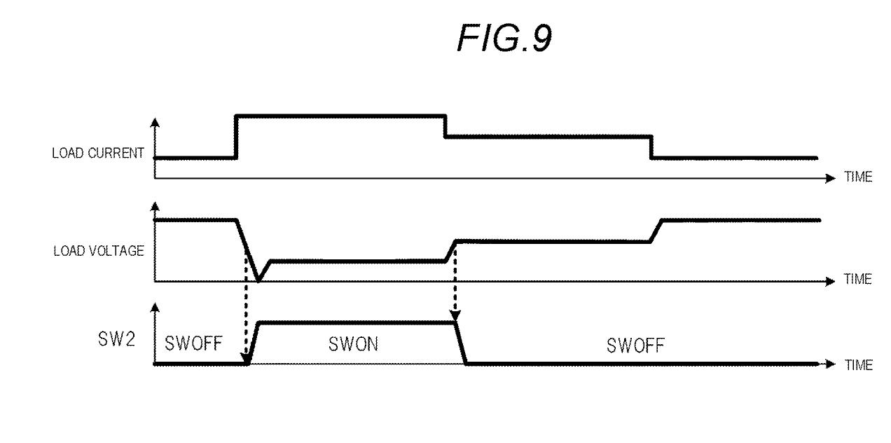

FIG. 9 is a timing chart showing a load current, a load voltage, and a state of the first switch 2 that are achieved during a period T1 in FIG. 8. There may be a case where electric power feed from the external power supply 60 will fail to catch up with an increase in load current even when the first switch 2 is turned off to shut off the electric discharge from the secondary battery 70 to the load 80. Accordingly, the gate voltage control unit 52 and the switch control unit 3 control turning on and off the FET 51 and the first switch 2 according to the state of the load current. For instance, when the load 80 is a portable phone, a load current achieved during transmission operation becomes greater than a load current achieved during receiving operation. As shown in FIG. 9, when the load current momentarily increases, the load voltage drops. However, when the load voltage falls below a predetermined threshold value, the switch control unit 3 turns on the first switch 2. The terms “predetermined threshold value” correspond to a charge complete voltage that is a value intended for protecting the battery from being charged to an overvoltage. In addition to the electric power feed from the external power supply 60, electric power feed from the secondary battery 70 is thereby provided, so that the load voltage rises. Subsequently, when a decrease in load current and a rise in load voltage take place, the switch control unit 3 turns off the first switch 2.

### Fourth Embodiment

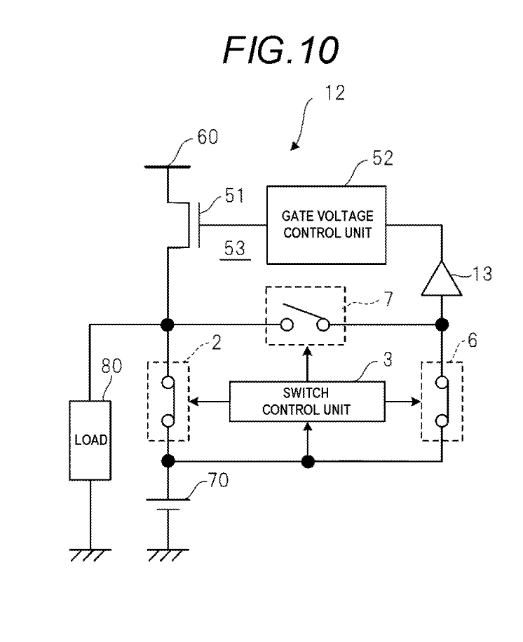

FIG. 10 is a block diagram showing a general configuration of a charge control circuit according to a fourth embodiment of the present invention. In FIG. 10, elements common to FIG. 4 to which a reference has been made are assigned the same reference numerals. A charge control circuit 12 of the present embodiment corresponds to a configuration in which an amplifier 13 is added to the charge control circuit 5 shown in FIG. 4. The amplifier 13 is connected to a point between the gate voltage control unit 52 and the second switch 6. Turning on/off of the amplifier 13 is in synchronism with the external power supply 60. When the external power supply 60 is in an ON position, the amplifier 13 is also turned on.

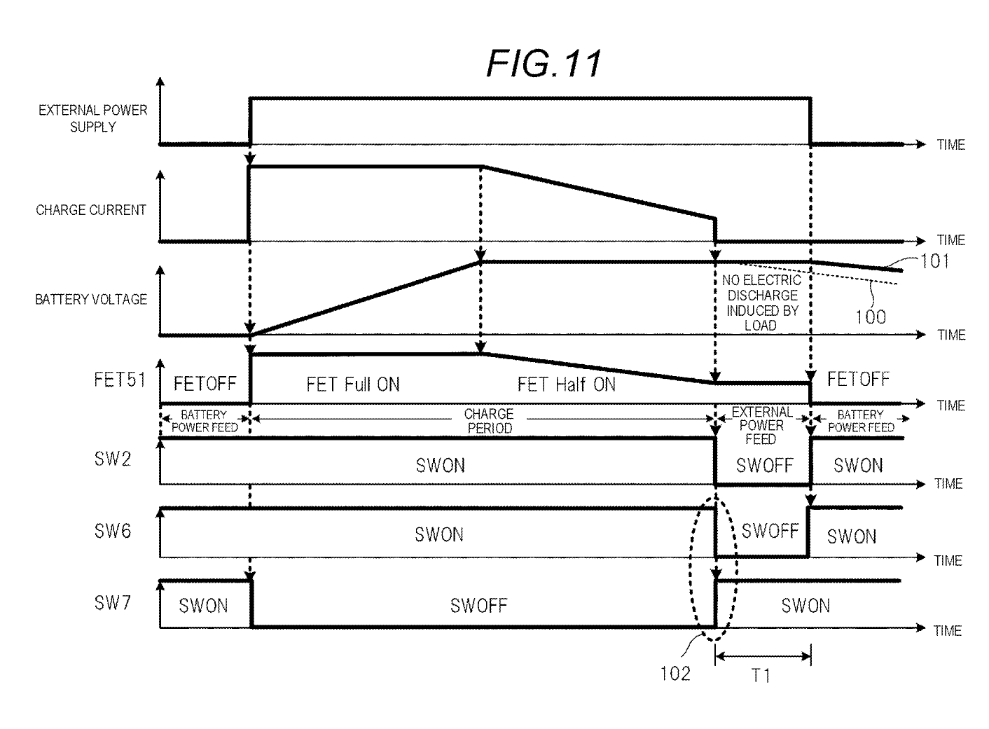

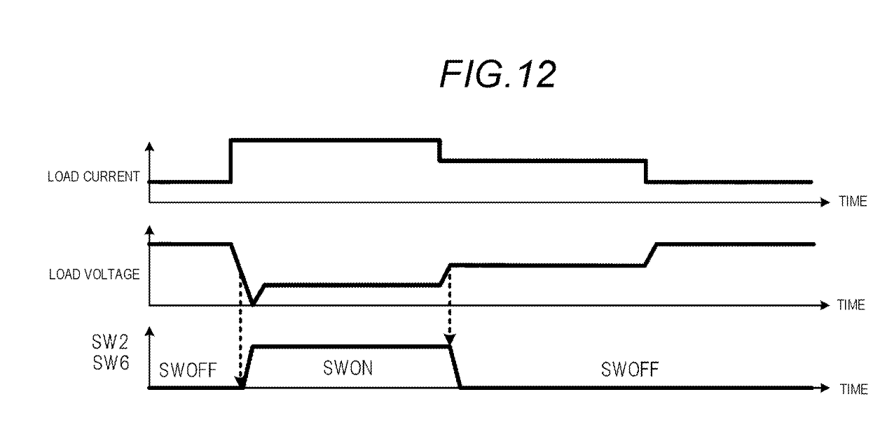

FIG. 11 is a timing chart showing operation of the charge control circuit 12 of the present embodiment. The operation of the external power supply 60, the charge current and the battery voltage of the secondary battery, and the operation of the FET 51, all of which are shown in the figure, correspond to an example general charge control flow of, in particular, a lithium ion battery. FIG. 12 is a timing chart showing a load current, a load voltage, a state of the first switch 2, and a state of the second switch 6 that are achieved during a period T1 in FIG. 11. Operations shown in FIGS. 11 and 12 are the same as those shown in FIGS. 5 and 6, and hence their repeated explanations are omitted.

As mentioned above, in the charge control circuit 12 of the present embodiment, deactivation of the first switch 2 and the second switch 6 and activation of the third switch 7 are performed at full charge of the secondary battery 70. Therefore, electric discharge from the secondary battery 70 to the load 80 can be shut off, and it becomes possible for the gate voltage control unit 52 to adjust a load voltage.

### Fifth Embodiment

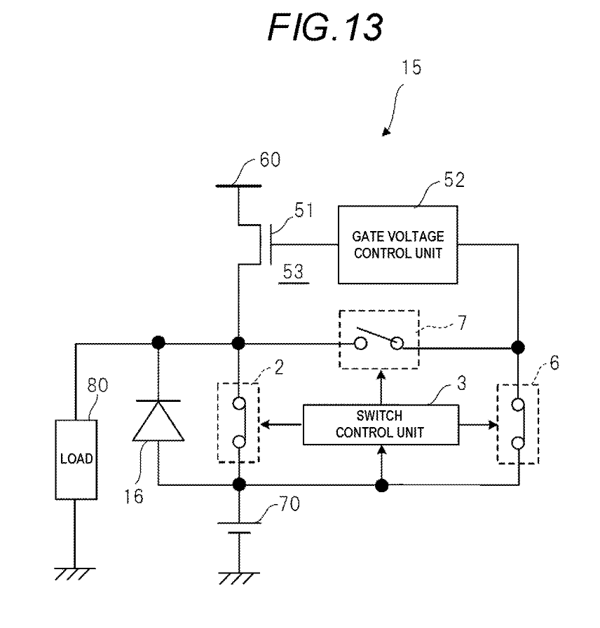

FIG. 13 is a block diagram showing a general configuration of a charge control circuit according to a fifth embodiment of the present invention. In FIG. 13, elements common to FIG. 4 to which a reference has been made are assigned the same reference numerals. A charge control circuit 15 of the present embodiment corresponds to a configuration in which a diode 16 is added to the charge control circuit 5 shown in FIG. 4. The diode 16 is connected in the forward direction from the secondary battery 70 to the load 80. In a case where an electric current consumed by the load 80 exceeds feed capability of the external power supply 60 or large variations occur in the electric current of the load 80 and poor response of the external power supply 60 take place on the occasion of power feed to the load 80 after accomplishment of full charge, electric power can be fed from the secondary battery 70 to the load 80 by means of provision of the diode 16. For instance, when the charge control circuit is applied to a portable phone, when large power is required as a result of an increase in transmission power, electric power can also be fed from the secondary battery 70 as well as from the external power supply 60.

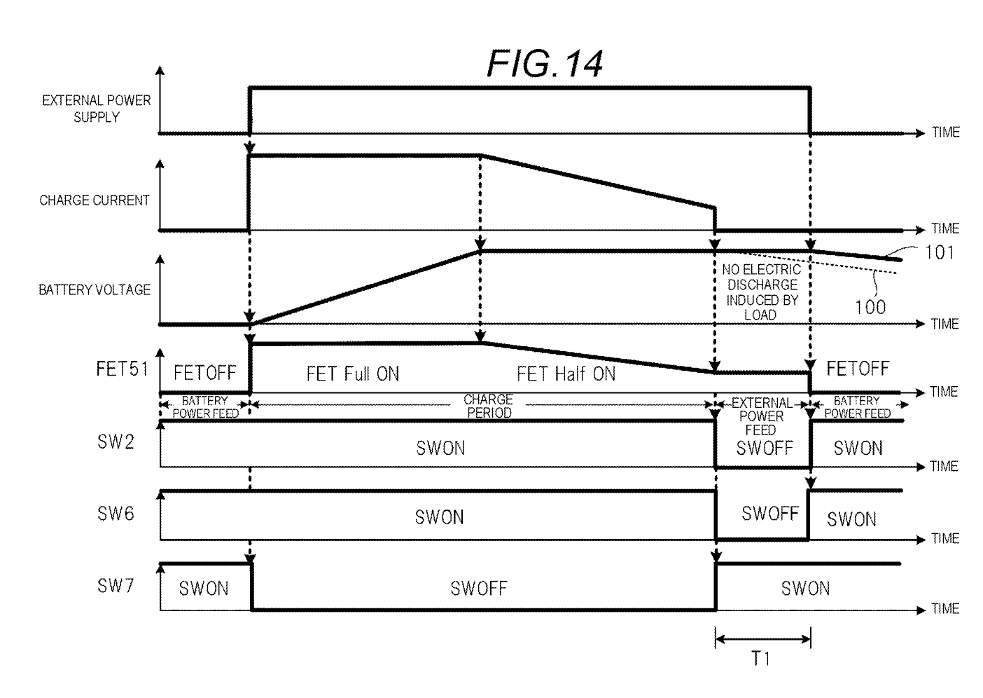

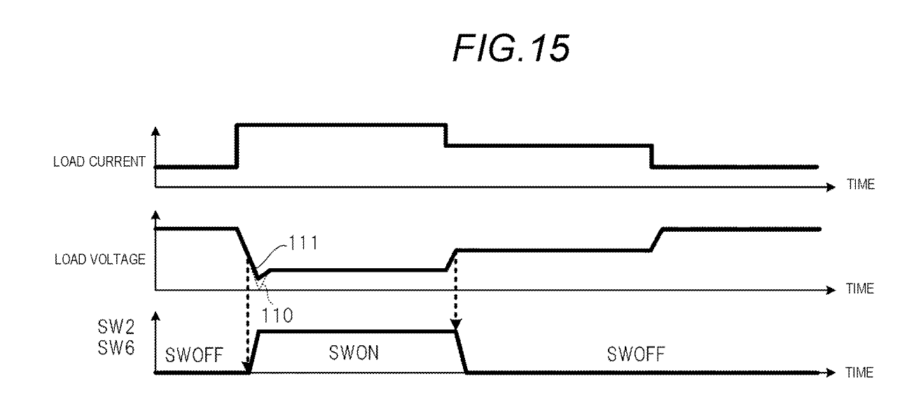

FIG. 14 is a timing chart showing operation of the charge control circuit 15 of the present embodiment. The operation of the external power supply 60, the charge current and the battery voltage of the secondary battery, and the operation of the FET 51, all of which are shown in the figure, correspond to an example general charge control flow of, in particular, a lithium ion battery. Operation shown in FIG. 14 is the same as that shown in FIG. 5, and hence its repeated explanation is omitted. FIG. 15 is a timing chart showing a load current, a load voltage, a state of the first switch 2, and a state of the second switch 6 that are achieved during a period T1 in FIG. 14. The diode 16 is provided in a direction from the secondary battery 70 toward the load 80; namely, in the forward diction, whereby a forward voltage (about 0.6V) is added to the load voltage, so that a drop in the load voltage can be lessened. A dotted line 110 shown in FIG. 15 designates a drop developed in load voltage when the diode 16 is not provided, and a solid line 111 designates a drop developed in load voltage when the diode 16 is provided. A drop in load voltage is reduced by provision of the diode 16.

### Sixth Embodiment

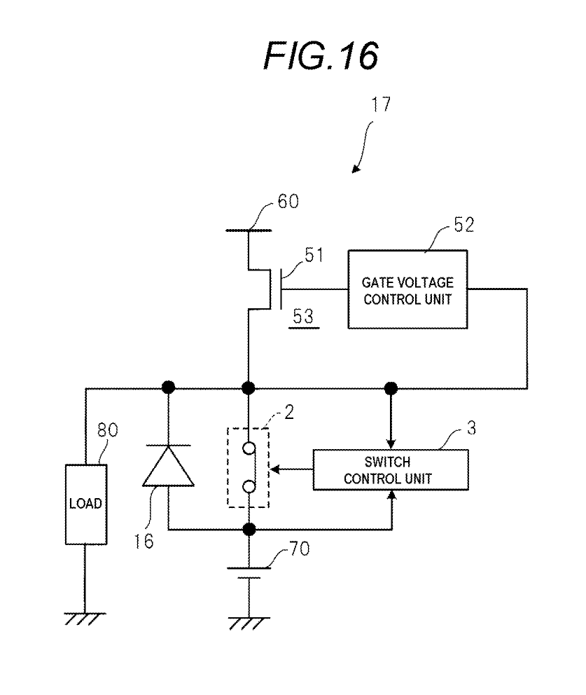

FIG. 16 is a block diagram showing a general configuration of a charge control circuit according to a sixth embodiment of the present invention. In FIG. 16, elements common to FIG. 1 to which a reference has been made are assigned the same reference numerals. A charge control circuit 17 of the present embodiment corresponds to an example provision of the diode 16 in the charge control circuit 1 shown in FIG. 1. Even in the present embodiment, the drop in load voltage can also be lessened. Likewise, the diode can also be connected in the forward direction from the secondary battery 70 to the load 80 in the charge control circuit 9 shown in FIG. 7 or the charge control circuit 12 shown in FIG. 10.

### Seventh Embodiment

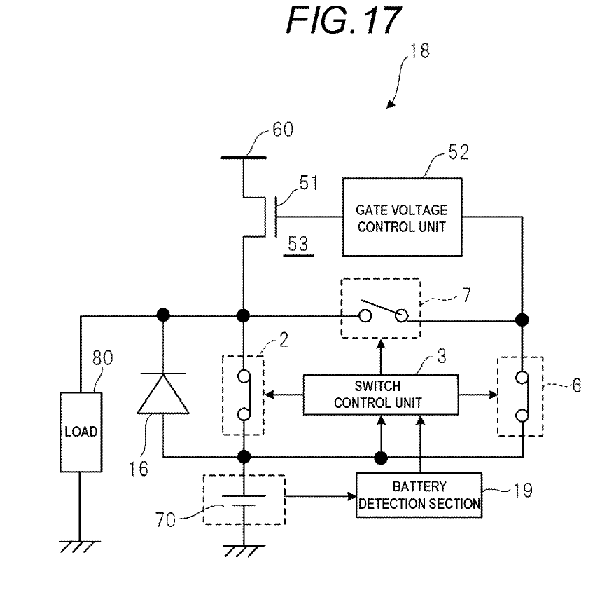

FIG. 17 is a block diagram showing a general configuration of a charge control circuit according to a seventh embodiment of the present invention. In FIG. 17, elements common to FIG. 13 to which a reference has been made are assigned the same reference numerals. A charge control circuit 18 of the present embodiment corresponds to a configuration in which a battery detection section 19 is added to the charge control circuit 15 shown in FIG. 13. The battery detection section 19 detects presence or absence of the secondary battery 70 or that the voltage of the secondary battery 70 falls below the predetermined threshold voltage (is in a deeply discharged state), and controls the switch control unit 3. When the secondary battery 70 is absent or when the voltage of the secondary battery 70 falls below the predetermined threshold voltage, the switch control unit 3 turns off both the first switch 2 and the second switch 6 and turns on the third switch 7, thereby feeding power to the load 80. Thus, when the secondary battery 70 is absent or when the voltage of the secondary battery 70 falls below the predetermined threshold voltage (is in the deeply discharged state), the thus-provided battery detection section 19 makes it possible to turn off the first switch 2 and the second switch 6 and turns on the third switch 7, thereby feeding power from the external power supply 60 to the load.

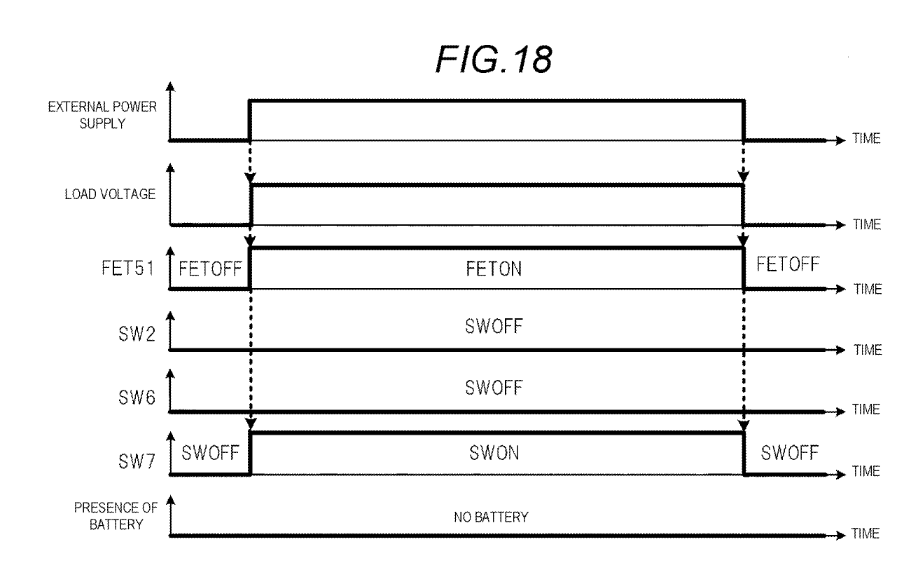

FIG. 18 is a timing chart showing operation of the charge control circuit 18 of the present embodiment achieved when the secondary battery 70 is absent. In the figure, when the external power supply 60 is turned on while absence of the secondary battery 70 is detected by the battery detection section 19, the gate voltage control unit 52 turns on the FET 51, whereupon a load voltage develops across the load 80. Since absence of the second battery 70 is already detected, the switch control unit 3 turns on the third switch 7 while holding the first switch 2 and the second switch 6 in an OFF position when the external power supply 60 is turned on.

### Eighth Embodiment

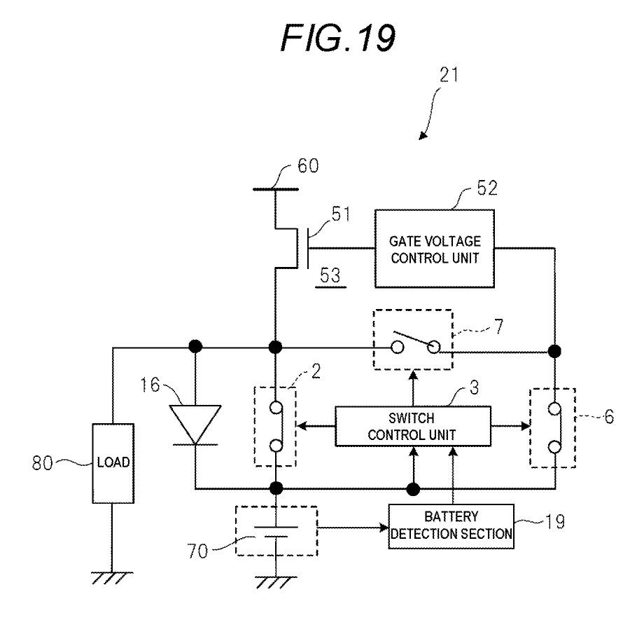

FIG. 19 is a block diagram showing a general configuration of a charge control circuit according to an eighth embodiment of the present invention. In FIG. 19, elements common to FIG. 17 to which a reference has been made are assigned the same reference numerals. A charge control circuit 21 of the present embodiment corresponds to a configuration in which the diode 16 of the charge control circuit 18 shown in FIG. 17 is set in a reverse direction. Namely, a cathode of the diode 16 is connected to the secondary battery 70, and an anode of the diode 16 is connected to the load 80. Connecting the diode 16 in a reverse direction makes it possible to shut off an electric discharge from the secondary battery 70 to the load 80.

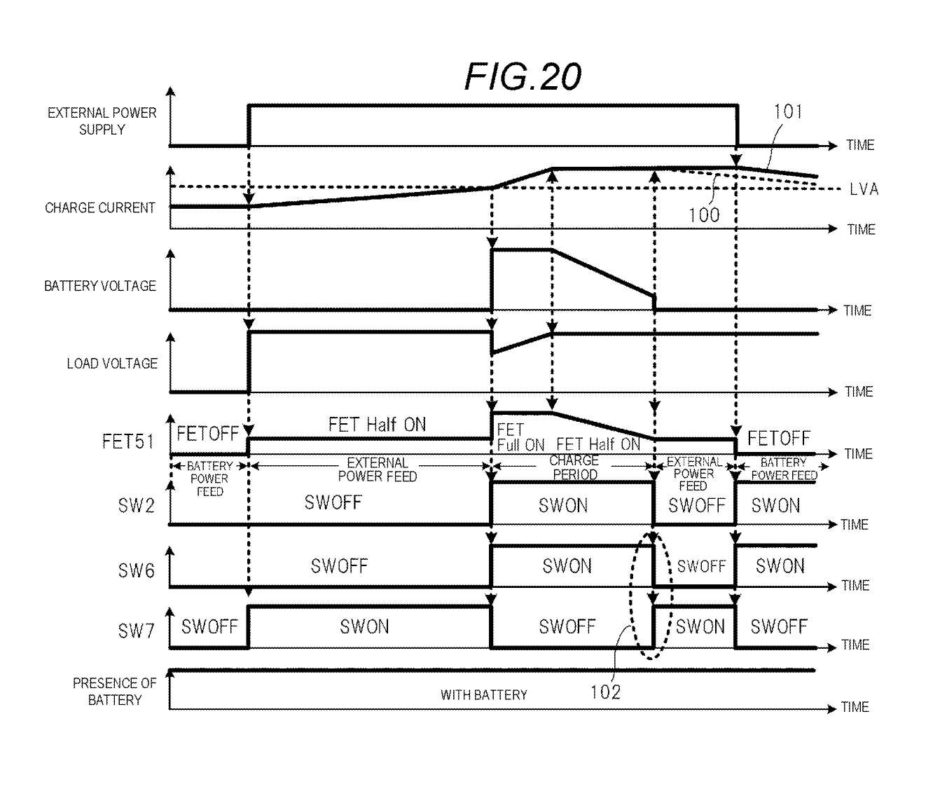

FIG. 20 is a timing chart showing operation of the charge control circuit 21 of the present embodiment. The external power supply 60, the charge current and the battery voltage of the secondary battery, and the operation of the FET 51 shown in the figure correspond to an example general charge control flow of, in particular, a lithium ion battery. In the figure, when the external power supply 60 is turned on while presence of the secondary battery 70 is detected by the battery detection section 19, the gate voltage control unit 52 turns on the FET 51, whereupon a load voltage develops across the load 80. Since presence of the secondary battery 70 is already detected, the switch control unit 3 turns on the third switch 7 while holding the first switch 2 and the second switch 6 in the OFF position. A nominal charge current flows to the secondary battery by way of the diode 16, whereupon the voltage of the secondary battery slightly rises. When the battery voltage exceeds the predetermined threshold value (LVA), the switch control unit 3 turns on both the first switch 2 and the second switch 6 and also turns off the third switch 7. The charge current abruptly flows as a result of the first switch 2 being turned on. The load voltage temporarily drops to an electrical potential equal to the battery voltage. When the secondary battery 70 has accomplished full charge, the gate voltage control unit 52 brings the FET 51 into a substantially OFF state, thereby varying ON resistance according to the load current. The switch control unit 3 turns off both the first switch 2 and the second switch 6 and also turns on the third switch 7. Subsequently, when the external power supply 60 is turned off, the switch control unit 3 turns on the first switch 2 and the second switch 6 and also turns off the third switch 7.

After the secondary battery 70 has accomplished full charge, the first switch 2 is turned off, so that electric discharge from the secondary battery 70 to the load 80 does not take place. Further, since the diode 16 is connected in the reverse direction, electric discharge to the load 80 naturally does not take place by way of the diode 16. A time shift in battery voltage designated by the dotted line 100 in FIG. 20 is induced by the related art charge control circuit 50 not having the first switch 2. When compared with a time shift in battery voltage of the charge control circuit 21 of the present embodiment designated by the solid line 101, it is found that the time shift in battery voltage designated by the dotted line 100 shows a large number of electric discharge from the secondary battery 70. During the course of power feed of the external power supply 60, both the secondary switch 6 and the third switch 7 are not concurrently turned off at timing designated by the dotted line 102 shown in FIG. 20. Further, the drop in load can be lessened by addition of the diode to be connected in the forward direction from the secondary battery 70 to the load 80. A configuration that yields a plurality of advantages can readily be made by combination of the charge control circuits described in connection with the first through eighth embodiments.

Although the present invention has been described in detail by reference to the specific embodiments, it is manifest to the skilled persons that the invention is susceptible to various alterations or modifications without departing the spirit and scope of the present invention.

The present patent application is based on Japanese Patent Application (No. 2009-004471) filed on Jan. 13, 2009, the entire subject matter of which is incorporated herein by reference.

### INDUSTRIAL APPLICABILITY

In connection with a charge control circuit used in charging a secondary battery, the present invention yields an advantage of preventing occurrence of a decrease in battery capacity even in a course of connection with an external power supply and also preventing the external power supply from acting as a factor that causes battery deterioration or overcharge, and can be applied to an electronic device using a secondary battery, such as a portable phone.

### REFERENCE SIGNS LIST

1, 5, 9, 12, 15, 17, 18, 21 CHARGE CONTROL CIRCUIT
2 FIRST SWITCH
3 SWITCH CONTROL UNIT
6 SECOND SWITCH
7 THIRD SWITCH
10, 11, 13 AMPLIFIER
16 DIODE
19 BATTERY DETECTION SECTION
51 FET
52 GATE VOLTAGE CONTROL UNIT
53 FEED CONTROL UNIT
60 EXTERNAL POWER SUPPLY
70 SECONDARY BATTERY
80 LOAD

1-7. (canceled)

8. A charge control circuit, comprising:
a secondary battery;
an external power supply;
a load connected to the external power supply; and
a switch connected to a point between a connection path from the external power supply to the load and the secondary battery, the switch being capable of switching between electrical conduction and shutting off of a charging path from the external power supply to the secondary battery and switching between electrical conduction and shutting off of a discharging path from the secondary battery to the load, wherein
the switch is electrically conducted when the secondary battery is being charged, and the switch is shut off when the secondary battery has accomplished full charge.

9. The charge control circuit according to claim 8, comprising:
a feed control unit that controls power feed from the external power supply to the secondary battery or the load; and
a switch control unit that controls the switch.

10. The charge control circuit according to claim 9, wherein the switch is referred to as a first switch, and
the charge control circuit comprises:
a second switch connected between the secondary battery and the feed control unit; and
a third switch connected between the first switch and the second switch, wherein
the switch control unit electrically conducts the first switch and the second switch and shuts off the third switch when the secondary battery is charged with the external power supply, and the switch control unit shuts off the first switch and the second switch and electrically conducts the third switch when the secondary battery has accomplished full charge.

11. The charge control circuit according to claim 10, wherein the second switch and the third switch are amplifiers, respectively.

12. The charge control circuit according to claim 10, comprising an amplifier connected between the feed control unit and the second switch.

13. The charge control circuit according to claim 8, comprising a diode connected in a forward direction from the secondary battery to the load.

14. The charge control circuit according to claim 13, comprising a battery detection section that detects presence or absence of the secondary battery or that a voltage of the secondary battery is substantially zero so as to control the switch control unit.

15. The charge control circuit according to claim 8, comprising:
a diode connected in a reverse direction from the secondary battery to the load; and
a battery detection section that detects presence or absence of the secondary battery or that a voltage of the secondary battery is substantially zero so as to control the switch control unit.

16. An electronic device being provided with the charge control circuit as set forth in claim 8.
